(19) United States
(12) Patent Application Publication
(10) Pub. No.: US 2013/0048578 A1
(43) Pub. Date: Feb. 28, 2013

(54) Water Bottle with Pressurized Pump Filtration System

(71) Applicants: Mathew Inskeep, (US); Jhan Lennon, (US)

(72) Inventors: Mathew Inskeep, (US); Jhan Lennon, (US)

(21) Appl. No.: 13/591,329

(22) Filed: Aug. 22, 2012

Related U.S. Application Data
(60) Provisional application No. 61/514,516, filed on Aug. 29, 2011.

(51) Int. Cl. B01D 35/027

(52) U.S. Cl. 210/808; 210/244

(57) ABSTRACT

A water bottle with filter is disclosed. The portable water bottle has removable top and disposable filter with integrated pressurized hand pump to provide water filtration and delivery to the user.

This application claims the benefit and priority of U.S. Ser. No. 61/514,516 filed Aug. 29, 2011. The entire disclosure of the above application is incorporated herein by reference.

### FIELD

The present disclosure relates generally to water filtering containers and more specifically to a water bottle with an integrated replaceable, disposable filter with pressurized pump.

### BACKGROUND

The practical need for filtered clean water in a portable bottle is well established. The taste and safety of potable water is paramount to the consuming public. While there exist in the commercial marketplace various water bottles with filtering capabilities, they require the water to be aspirated through the filter by the user sucking water from the bottle via one's mouth. Because the pressure to pull the water through the filter within the bottle is provided by one's mouth strength, the amount of water properly filtered is inconsistent. Delivery of the water to the drinker is often difficult and requires suction far greater than one is able to provide.

Other plastic based water bottles push water through the filter by having the user squeeze the sides of the bottle to push the water through the filter. This again provides an inconsistent and unpredictable water flow. Additionally, this type of water filter bottle requires the water to be contained in a plastic bottle. Some consumers prefer using stainless steel or aluminum because of the perceived and documented negative health consequences of leaching plastic composites found in plastic water bottles (i.e. PCBs). The present invention can be used with a metal or stainless steel water bottle since the water is delivered via the hand pump that pressurizes the water bottle. The present invention provides a consumer friendly easy to use water filtration bottle utilizing pressurization that can be utilized in aluminum or stainless steel water bottles.

There are other portable water filtration devices that can be used to intake water and purify via a pump that allow tor storage of the water after pump filtration. The pumps are often not integrated into a singular water bottle and are cumbersome to operate, particularly for personal, portable water receptacle. They also generally rely on gravity feed or pump rather than an air pressurized container. The delivery of filtered water can be inconsistent through these pumps or gravity feed filtration devices. The present invention with its pressurized delivery allows for consistent flow of filtered water to the user.

A primary object of the present invention is to provide a portable filtering bottle.

Another object of the present invention is to provide a portable filtering bottle functioning as a personal water purification system that will save the user from continually purchasing single use water bottles with water.

Another object of the present invention is to provide a portable filtering water bottle with easy to use band pump that pressurizes the bottle to deliver the water through the filter in a consistent manner.

The present invention overcomes the limitations of the prior art by providing a personal water filtration bottle comprising of a bottle made from aluminum, stainless steel or plastic with an integrated pressurized hand operated pump with disposable, replaceable water filter.

### SUMMARY

The present invention is in the field of water filtration and containers holding water. More particularly, the present invention is a water bottle container utilizing an integrated filtration system that uses a hand operated pump to pressurize the container and push the water through the disposable filter and ultimately out of the container to the user for ingestion. The water bottle can be made of stainless steel aluminum or plastic. Once the bottle is pressurized with air pumped into the bottle, a button releases the pressure thereby pushing the water through the filter and out the delivery spout and to the user. The device incorporates a filter, the pressurized pump and bottle into a singular unit.

What is claimed is a water storage device with an integrated disposable filter with and hand operated pump for pressurizing the container and purifying the water, pushing it through the filter to the user for ingestion and method of operating same. The top of the bottle is removable and the filter is removable and disposable.

### DRAWINGS

FIG. 1 illustrates an exemplary embodiment of the water bottle with hand pump pressurized filtration.

### DETAILED DESCRIPTION

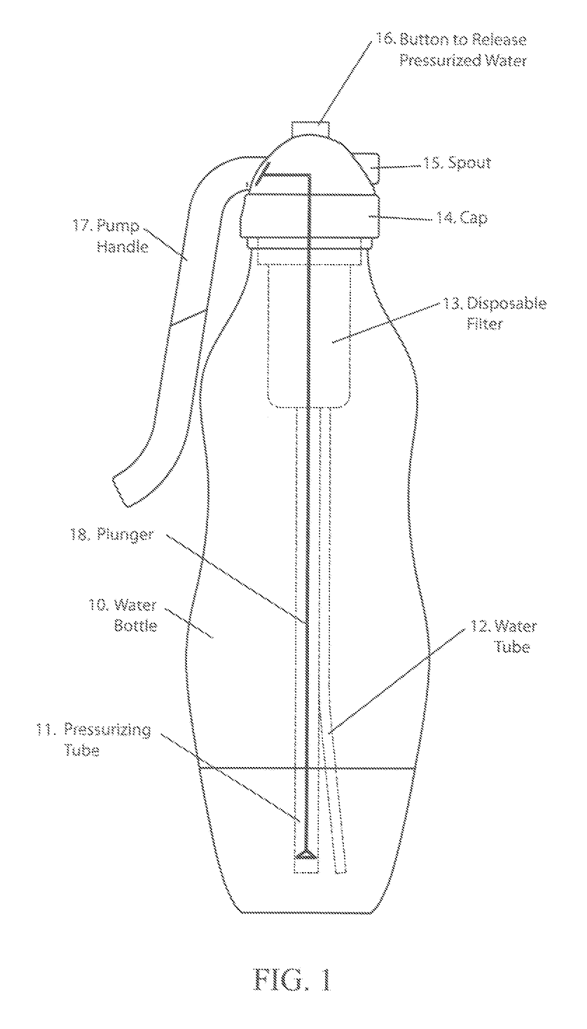

FIG. 1 illustrates an exemplary embodiment of a water bottle with integrated filter and hand operated pressurizing pump. The pressurizes filter water bottle 10 may he made of stainless steal, aluminum or plastic. The filter water bottle includes a pressurizing tube 11 that delivers air into the bottle to pressurize. The unfiltered water placed in the bottle from the removable top is delivered through a tube that pushes the pressurized water through the bottle and through the filter 13 and out through the spout 15 and to the user to ultimately ingest.

The water is pressurized by forcing air into the bottle via the pump handle 17 which manipulates the pump arm and plunger 18. Once air is trapped into the bottle it is pressurized. When the user presses the button on the top of the bottle 16, the compressed air is released forcing the water up through the water tube 12 and through the filter 13 and out through the 15 spout.

1. A portable water bottle with removable top and disposable filter with integrated pressurized hand pump water filtration.

2. Method for purifying and delivering filtered water in a water bottle by virtue of an integrated pressurized hand pump filtration.
